(19) United States
(12) Patent Application Publication
(10) Pub. No.: US 2017/0048098 A1
(43) Pub. Date: Feb. 16, 2017

(54) RECEIVING APPARATUS AND WARNING INFORMATION TRANSFER METHOD

(71) Applicant: FUJITSU LIMITED, Kawasaki-shi (JP)

(72) Inventors: HIDETAKA KAWAHARA, Shimotsuga (JP); Hiromichi Makishima, Oyama (JP)

(73) Assignee: FUJITSU LIMITED, Kawasaki-shi (JP)

(21) Appl. No.: 15/157,705

(22) Filed: May 18, 2016

(30) Foreign Application Priority Data
Aug. 12, 2015 (JP) 2015-159609

(51) Int. Cl. H04L 12/24; H04B 10/079

(52) U.S. Cl. CPC H04L 41/06; H04B 10/0795

(57) ABSTRACT

A receiving apparatus includes: a memory configured to store information including priority ranks for accessing pieces of warning information; and a controller configured to extract the pieces of warning information from signals having different transmission rate, access, in descending order of the priority ranks, the pieces of warning information stored in a storage, and execute a transfer process.

### CROSS-REFERENCE TO RELATED APPLICATION

This application is based upon and claims the benefit of priority of the prior Japanese Patent Application No. 2015-159609, filed on Aug. 12, 2015, the entire contents of which are incorporated herein by reference.

### FIELD

The embodiments discussed herein are related to a receiving apparatus and a warning information transfer method.

### BACKGROUND

In the Optical Transport Network (OTN) transmission system defined in the International Telecommunication Union (ITU)-Telecommunication (T) G.709 standard, a client signal flowing into an optical network is transmitted as an Optical channel Transport Unit (OTU). An OTU stores, in addition to a payload for storing a client signal, the overhead (OH) of an Optical channel Payload Unit (OPU) and the OH of an Optical channel Data Unit (ODU).

Related technologies are disclosed in Japanese Unexamined Utility Model Registration Application Publication No. 04-135045, Japanese Laid-open Patent Publication No. 06-319186, or Japanese Laid-open Patent Publication No. 11-284692.

### SUMMARY

According to an aspect of the embodiments, a receiving apparatus includes: a memory configured to store information including priority ranks for accessing pieces of warning information; and a controller configured to extract the pieces of warning information from signals having different transmission rate, access, in descending order of the priority ranks, the pieces of warning information stored in a storage, and execute a transfer process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a transmission system;

FIG. 2 illustrates an example of an ADM;

FIG. 3 illustrates an example of an alarm transfer unit;

FIG. 4 illustrates an example of a priority rank table;

FIG. 5 illustrates an example of a transfer determination table;

FIG. 6 illustrates an example of a setting table;

FIG. 7 illustrates an example of a processing operation of a scheduler unit involved in a transfer request process;

FIG. 8 illustrates an example of a processing operation of a generation unit involved in a transfer process; and

FIG. 9 illustrates an example of a timing chart of signals involved in alarm transfer.

### DESCRIPTION OF EMBODIMENTS

A plurality of types of OTU includes an OTU capable of storing, in one signal, a plurality of types of client signal whose transmission rates are different. For example, an OTU0 stores client signals up to approximately 1.25 Gbps, and an OTU1 stores client signals up to approximately 2.5 Gbps. An OTU2 stores client signals up to approximately 10 Gbps, an OTU3 stores client signals up to approximately 40 Gbps, and an OTU4 stores client signals up to approximately 100 Gbps. An OTU stores a plurality of types of ODU.

In a plurality of types of ODU, for example, an ODU0 stores client signals up to approximately 1.25 Gbps, and an ODU1 stores client signals up to approximately 2.5 Gbps. An ODU2 stores client signals up to approximately 10 Gbps, an ODU3 stores client signals up to approximately 40 Gbps, and an ODU4 stores client signals up to approximately 100 Gbps.

An ODU stores lower-level ODUs. For example, the ODU4 may store the ODU0, the ODU1, the ODU2, and the ODU3, and the ODU3 may store the ODU0, the ODU1, and the ODU2. An ODU employs a multi-stage method in which lower-level ODUs are able to be nested in a plurality of stages and stored. For example, an ODU that stores lower-level ODUs may be a high-order (HO)-ODU. An ODU that does not store lower-level ODUs may be a low-order (LO)-ODU. The ODU4, which employs the multi-stage method, may be an ODU in which, for example, two HO-ODU2s and two HO-ODU3s are multiplexed, the two HO-ODU2s each storing eight LO-ODU0s, the two HO-ODU3s each storing four LO-ODU2s.

For example, a separation unit of a transmission apparatus extracts data of LO-ODUs from HO-ODUs included in an OTU received from an OTN. A cross-connect unit of the transmission apparatus performs data switching in units of one LO-ODU. A multiplexing unit of the transmission apparatus stores, in an OTU, and outputs an HO-ODU in which data of LO-ODUs is multiplexed for which switching has been performed by the cross-connect unit.

The transmission apparatus includes an alarm transfer unit (Alarm Propagation) that detects an alarm for each layer or port and generates a transfer signal for the detected alarm. The alarm transfer unit generates an alarm transfer signal in accordance with the type of the detected alarm, and transfers the generated alarm transfer signal to the next stage. The alarm transfer signal is, for example, a signal having an OH byte into which alarm information is inserted, or a signal replaced as a maintenance signal such as, for example an alarm indication signal (AIS), an open connection indication (OCI) signal, or a lock (LCK) signal.

The alarm transfer unit may generate an alarm transfer signal in accordance with the type of an alarm and output the alarm transfer signal to a transmission apparatus on the opposing side.

In transmission apparatuses, due to larger transmission capacities and capturing of various signals, the variety of conditions regarding, for example, types of alarm and timings at which alarms occur has been increasing. Thus, in transmission apparatuses, in the case where all the conditions the variety of which has been increasing are tried to be satisfied, alarm transfer units are provided for the respective conditions, and thus the circuit scale increases when a large scale integration (LSI) or a field-programmable gate array (FPGA) is included. In transmission apparatuses, alarm transfer units are provided at monitoring points that occur for individual layers or ports for types of signal. In transmission apparatuses, in the case where layers or ports are additionally provided, alarm transfer units are added in accordance with the number of layers added or the number of ports added.

For example, in the case of a transmission apparatus having a configuration with 4 OTU1 ports as client inputs and 1 OTU2 port as a network output, a total of 13 monitoring points, which are OTU1×4+ODU0×8+OTU2×1, occur since an OTU1 stores a maximum of 2 ODU0s. Thus, since alarm transfer units are arranged at the 13 monitoring points in total in the transmission apparatus, a total of 13 alarm transfer units are provided.

For example, in the case of a transmission apparatus having a configuration with 10 OTU2 ports as client inputs and 1 OTU4 port as a network output, an OTU2 stores a maximum of 8 ODU0s. Thus, a total of 91 monitoring points, which are OTU2×10+ODU0×80+OTU4×1, are prepared, the monitoring points being for example control circuits, such as alarm transfer units, that process the header of each client signal. Thus, since alarm transfer units are arranged at the 91 monitoring points in total in the transmission apparatus, a total of 91 alarm transfer units are provided. In the transmission apparatus, the number of arranged alarm transfer units may be increased in accordance with layer addition or port addition, the circuit scale may increase, and the amount of power consumption may also increase.

Embodiments described below may be appropriately combined in the range where no contradiction occurs.

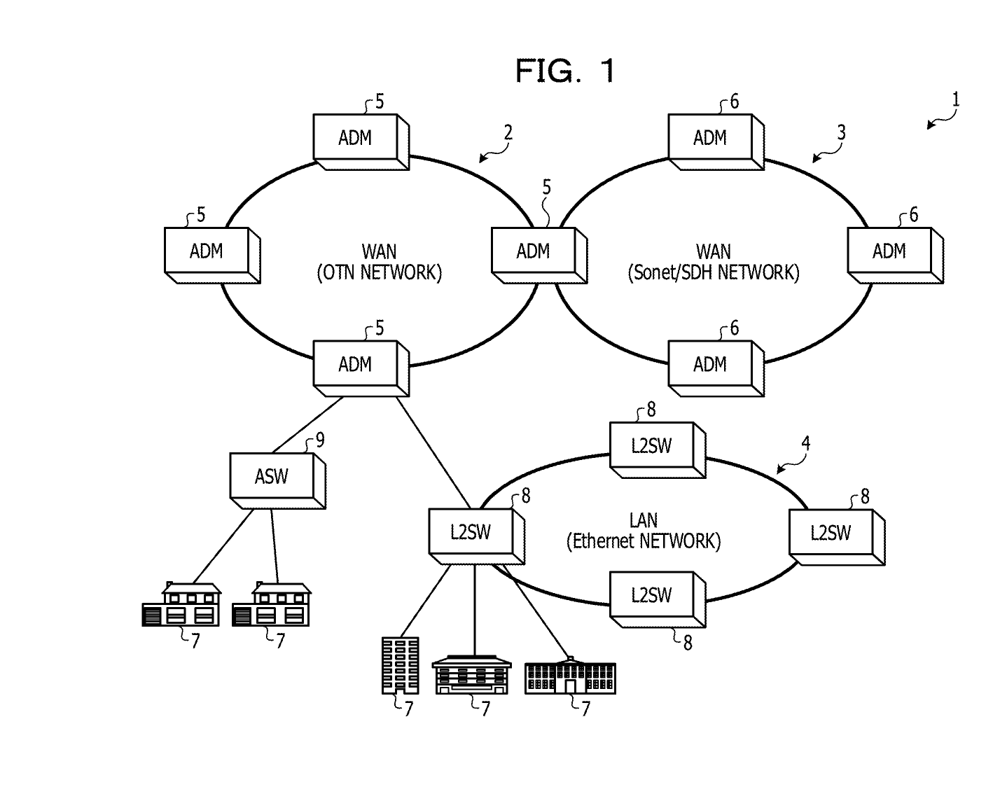

FIG. 1 illustrates an example of a transmission system. A transmission system 1 includes a wide area network (WAN) 2 on an OTN side, a WAN 3 on a Synchronous Optical Network/Synchronous Digital Hierarchy (Sonet/SDH) side, and a local area network (LAN) 4 on an Ethernet® side. Optical wavelength multiplexing devices (hereinafter simply referred to as add-drop multiplexers (ADMs)) 5, which are a plurality of transmission apparatuses, are connected to the WAN 2 on the OTN side. A plurality of ADMs 6 are also connected to the WAN 3 on the Sonet/SDH side.

A plurality of layer 2 switches (L2SWs) 8, which are connected to clients 7, are connected to the LAN 4. An ADM 5 among the ADMs 5 in the WAN 2 on the OTN side is connected to an L2SW 8 among the L2SWs 8 in the LAN 4 and an aggregate switch (ASW) 9, and relays communication between clients 7 and the WAN 2. The ADM 5 is connected to each of the other ADMs 5 in the WAN 2 on the OTN side, and for example communicates an OTU2 and an OTU4 mutually. The ADM 5 may be, for example, a transmission apparatus having a configuration with 10 OTU2 ports as client inputs and 1 OTU4 port as a network output.

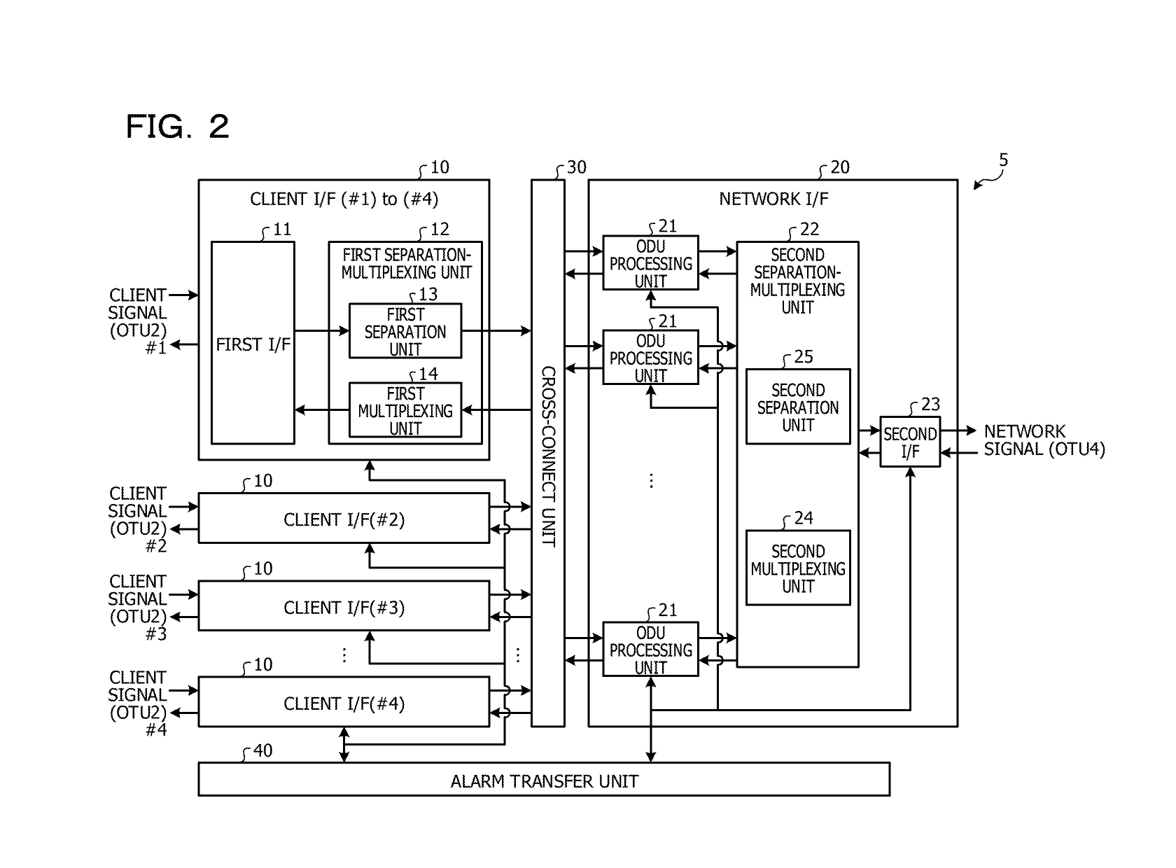

FIG. 2 illustrates an example of an ADM 5. The ADM 5 illustrated in FIG. 2 includes client interfaces (I/Fs) 10, a network I/F 20, a cross-connect unit 30, and an alarm transfer unit 40. The client I/Fs 10 are interfaces that govern communication with ADMs 5 on a client side. The network I/F 20 is an interface that governs communication with an ADM 5 on a network side. The cross-connect unit 30 is a switch for performing switching and connecting for communication between the client I/Fs 10 and the network I/F 20 and between the client I/Fs 10.

Each client I/F 10 includes a first I/F 11 and a first separation-multiplexing unit 12. The first I/F 11 is, for example, an interface that governs communication with an ADM 5 on the client side. The first I/F 11 mutually communicates a client signal, an OTU2, with the ADM 5 on the client side. The first separation-multiplexing unit 12 includes a first separation unit 13 and a first multiplexing unit 14. The first separation unit 13 monitors input of a client signal (OTU2) through the first I/F 11, and separates the client signal, the OTU2, into ODU0s, based on the monitoring result. The first separation unit 13 transmits the ODU0s to the cross-connect unit 30. The first multiplexing unit 14 stores ODU0s from the cross-connect unit 30 in an OTU2, and outputs the OTU2 via the first I/F 11.

The network I/F 20 includes ODU processing units 21, a second separation-multiplexing unit 22, and a second I/F 23. The ODU processing units 21 are processing units for monitoring OHs and the like included in ODU0s. The second separation-multiplexing unit 22 includes a second multiplexing unit 24 and a second separation unit 25. The second multiplexing unit 24 generates an OTU4 by multiplexing a plurality of ODU0s, based on a monitoring result. The OTU4 is, for example, a multi-stage signal in which a plurality of ODU0 are nested in a plurality of stages and multiplexed in an ODU2. The second I/F 23 is an interface that governs communication with an ADM 5 on the network side. The second multiplexing unit 24 generates an OTU4 by multiplexing ODU0s from the cross-connect unit 30, and outputs the OTU4 via the second I/F 23.

The second separation unit 25 extracts, via the second I/F 23, data of ODU0s from HO-ODUs included in an OTU4. The ODU processing units 21 extract the data of the ODU0s extracted by the second separation unit 25, and output the extracted data of the ODU0s to the cross-connect unit 30.

In the case where, for example, the ADM 5 has a configuration with 10 OTU2 ports, 1 OTU4 port, and 80 ODU0 ports, there are provided 10 first I/Fs 11 corresponding to OTU2s, 1 second I/F 23 corresponding to an OTU4, and 80 ODU processing units 21 corresponding to ODU0s. Each first I/F 11 is a monitoring point for monitoring alarm information regarding an OTU2. The second I/F 23 is a monitoring point for monitoring alarm information regarding the OTU4. The ODU processing units 21 are monitoring points for monitoring alarm information regarding the ODU0s.

For example, a client I/F 10 #1 inputs and outputs an OTU2 #1, a client I/F 10 #2 inputs and outputs an OTU2 #2, a client I/F 10 #3 inputs and outputs an OTU2 #3, and a client I/F 10 #4 inputs and outputs an OTU2 #4. For example, a client I/F 10 #5 inputs and outputs an OTU2 #5, a client I/F 10 #6 inputs and outputs an OTU2 #6, a client I/F 10 #7 inputs and outputs an OTU2 #7, and a client I/F 10 #8 inputs and outputs an OTU2 #8. For example, a client I/F 10 #9 inputs and outputs an OTU2 #9, and a client I/F 10 #10 inputs and outputs an OTU2 #10.

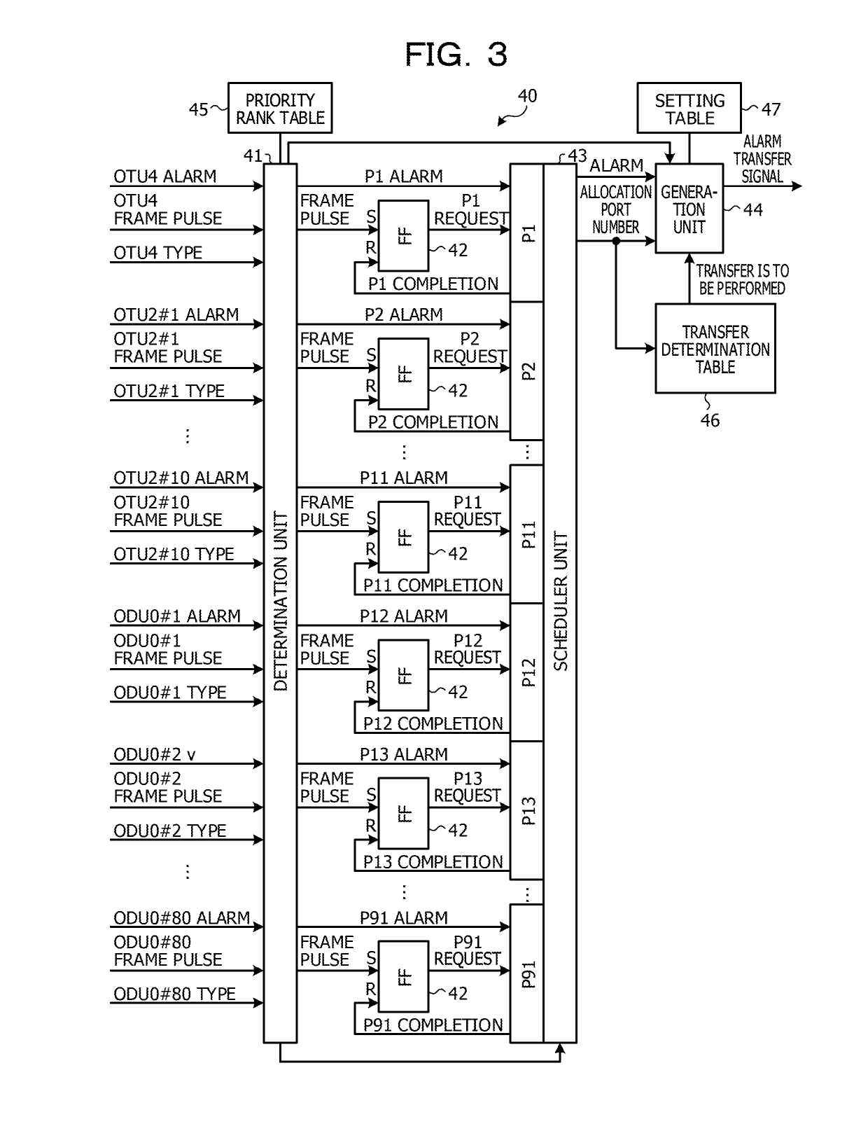

FIG. 3 illustrates an example of the alarm transfer unit 40. The alarm transfer unit 40 illustrated in FIG. 3 includes a determination unit 41, FFs 42, a scheduler unit 43, a generation unit 44, a priority rank table 45, a transfer determination table 46, and a setting table 47.

The determination unit 41 is connected to monitoring points such as the first I/Fs 11, the ODU processing units 21, and the second I/F 23, and may also be, for example, an extraction unit that extracts alarm information such as alarms, frame pulses, and type categories from the monitoring points such as the first I/Fs 11, the ODU processing units 21, and the second I/F 23. The alarms are warning information stored in signals. The frame pulses are frame pulses of the signals. The type categories are for example signal categories used to identify signal categories, which are OTU2, OTU4, and ODU0, of the signals. The determination unit 41 extracts alarm information such as alarms, frame pulses, and type categories from ODU2s passing through the respective first I/Fs 11, and extracts alarm information regarding a maximum of 10 ports of OTU2. The determination unit 41 extracts alarm information such as an alarm, a frame pulse, and a type category from an OTU4 passing through the second I/F 23. The determination unit 41 extracts alarm information such as alarms, frame pulses, and type categories from ODU0s passing through the respective ODU processing units 21, and extracts alarm information regarding a maximum of 80 ports of ODU0.

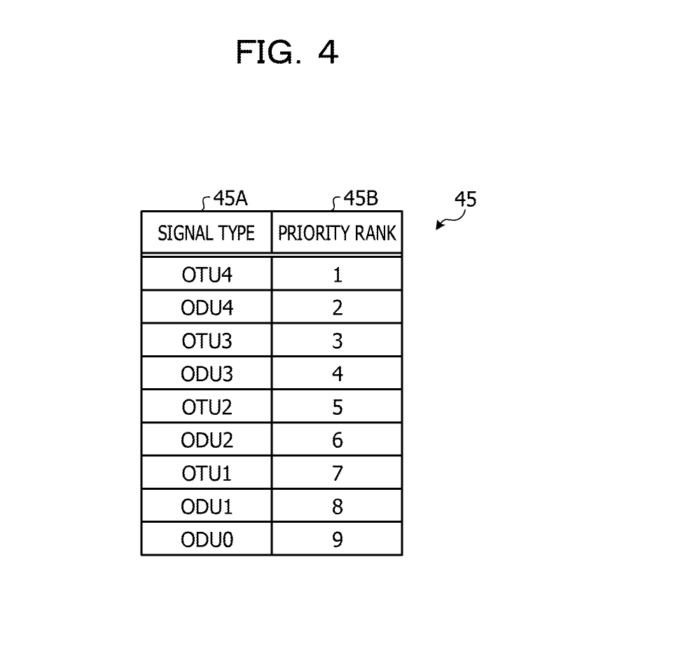

FIG. 4 illustrates an example of a priority rank table. The priority rank table 45 illustrated in FIG. 4 may be a rank recording unit storing a table or the like in which priority ranks 45B for execution of an alarm transfer process in a prioritized manner are recorded for respective signal types 45A used to identify signal categories. Regarding the signal types 45A, for example, there are nine signal categories such as OTU4, ODU4, OTU3, ODU3, OTU2, ODU2, OTU1, ODU1, and ODU0. One frame period of the OTU4 and that of the ODU4 may be, for example, 1.168 microseconds (μs), one frame period of the OTU3 and that of the ODU3 may be, for example, 3.305 μs, and one frame period of the OTU2 and that of the ODU2 may be, for example, 12.191 μs. One frame period of the OTU1 and that of the ODU1 may be, for example, 48.971 μs, and one frame period of the ODU0 may be, for example, 98.354 μs. The frame period of the OTU4 is shorter than the frame periods of the other frames. For example, in the case where a processing time of three clocks is used for generation of an alarm transfer signal once, and a request for the OTU4 and requests for the 80 ODU0s occur simultaneously, when processing for the 80 ODU0s is prioritized, 80×3 clocks=240 clocks are used as a time. For example, in the case where it is assumed that a system clock is 164 MHz, 240×6.1 nanoseconds (ns)=1.46 μs. Thus, in the case where the processing for the 80 ODU0s is prioritized, the processing time exceeds one frame period of the OTU4, and thereby processing for the OTU4 is not performed in time. Thus, a frame (a signal) whose frame period is short is processed in a prioritized manner. Thus, for example, the priority rank of the OTU4 may be the first rank, which is the highest rank, that of the ODU4 may be the second rank, that of the OTU3 may be the third rank, that of the ODU3 may be the fourth rank, that of the OTU2 may be the fifth rank, that of the ODU2 may be the sixth rank, that of the OTU1 may be the seventh rank, that of the ODU1 may be the eighth rank, and that of the ODU0 may be the ninth rank.

The determination unit 41 assigns an allocation port P1, which is an allocation port having the first-priority rank within the scheduler unit 43, to alarm information having the first priority rank among pieces of alarm information extracted from the first I/Fs 11, the ODU processing units 21, and the second I/F 23. Since there are 91 alarm-information monitoring points, the scheduler unit 43 is provided with a maximum of 91 allocation ports P1 to P91 for ports into which alarm information at the monitoring points is to be input. The determination unit 41 allocates an allocation port P2, which is an allocation port having the second priority rank, to alarm information having the second priority rank, and an allocation port P3, which is an allocation port having the third priority rank, to alarm information having the third priority rank. The determination unit 41 allocates the allocation ports P on the side of the scheduler unit 43 in accordance with the priority ranks. In the case where there are a plurality of pieces of alarm information of the same signal category, the determination unit 41 sets alarm information for a higher-level connection to a higher rank. For example, in the case of alarm information regarding ODU0s #21 and #22, the alarm information regarding the ODU0 #21 is set to a higher rank, and the alarm information regarding the ODU0 #22 is set to a lower rank.

The FFs 42 are provided at the respective allocation ports P, and each FF 42 outputs a request “H” to the scheduler unit 43 in accordance with input of a frame pulse included in alarm information allocated thereto. A request is information requesting a transfer of alarm information to the generation unit 44. In accordance with input of “H” indicating completion of output, the FF 42 switches and sets the request from “H” to “L”. The completion of output is information indicating that a transfer of alarm information to the generation unit 44 is completed.

The scheduler unit 43 may be, for example, a memory that stores, in the case where the scheduler unit 43 has received alarm information from the determination unit 41, an alarm regarding the alarm information, and an allocation port number so that the alarm is associated with the allocation port number. The allocation port number is a port number used to identify an allocation port P allocated to the alarm information. The scheduler unit 43 determines whether or not there are allocation ports P having a request “H”. In the case where there are allocation ports P having a request “H”, the scheduler unit 43 specifies an allocation port P having the highest priority rank among the allocation ports P having a request “H”. In the case where the scheduler unit 43 has specified an allocation port P having a request “H”, the scheduler unit 43 sets a BUSY mode to ON. The BUSY mode is a mode to prohibit specification of allocation ports P other than the allocation port P that is currently specified. The scheduler unit 43 reads out an alarm regarding and the allocation port number of the specified allocation port P, and outputs the alarm and the allocation port number, which have been read out, to the generation unit 44. After outputting the alarm and the allocation port number to the generation unit 44, the scheduler unit 43 sets the BUSY mode to OFF.

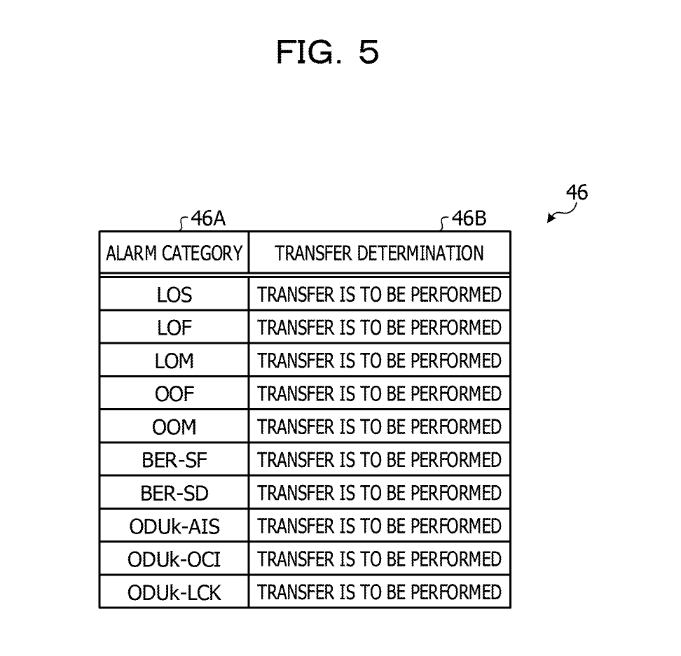

The generation unit 44 may be, for example, a controller that refers to, in the case where the generation unit 44 has received an alarm and an allocation port number, the transfer determination table 46 and determines whether or not the alarm is to be transferred. FIG. 5 illustrates an example of the transfer determination table 46. The transfer determination table 46 illustrated in FIG. 5 may be, for example, an information memory storing alarm categories 46A and pieces of transfer determination information 46B so that the alarm categories 46A are associated with the respective pieces of transfer determination information 46B indicating whether or not an alarm transfer is to be performed. The transfer determination table 46 may be provided at each of the monitoring points. The alarm categories 46A include, for example, alarms such as a loss of signal (LOS) alarm, a loss of frame (LOF) alarm, a loss of multi frame (LOM) alarm, an out of frame (OOF) alarm, and an out of multi frame (OOM) alarm. The alarm categories 46A include alarms such as bit error rate (BER)-severity failure (SF), bit error rate (BER)-severity defect (SD), ODUk-alarm indication signal (AIS), ODUk-OCI, ODUk-LCK, and the like.

The LOS alarm indicates a signal shutdown, the LOF alarm indicates an integration result of a loss of frame synchronization for 3 milliseconds (ms), the LOM alarm indicates an integration result of a loss of multi-frame synchronization for 3 ms, the OOF alarm indicates a loss of frame synchronization, and the OOM indicates a loss of multi-frame synchronization. BER-SF indicates a severity-failure bit error, and BER-SD indicates a severity-defect bit error. ODUk-AIS indicates an ODU alarm indication signal, ODUk-OCI indicates ODU open connection indication, and ODUk-LCK indicates ODU locked.

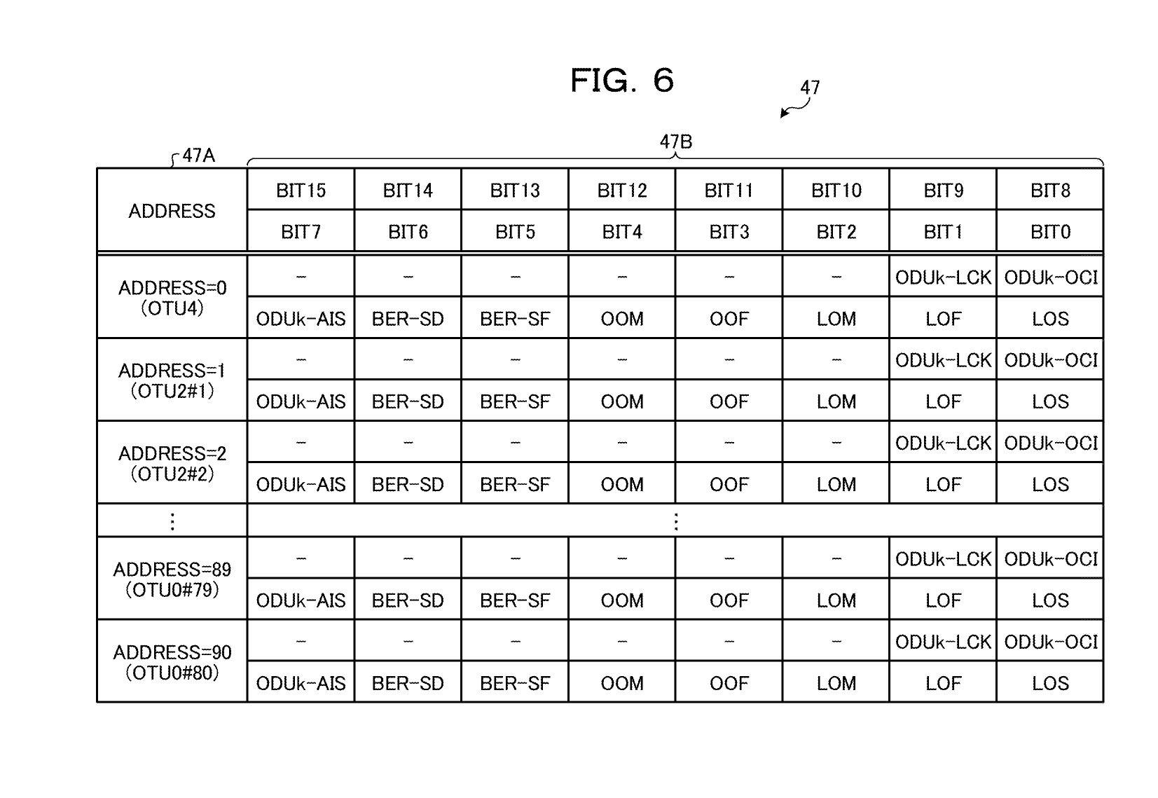

The generation unit 44 specifies a monitoring point corresponding to alarm information to which an allocation port P having the received allocation port number is allocated. The monitoring point may be acquired from the determination unit 41. The generation unit 44 specifies the monitoring point, which has been acquired from the determination unit 41, corresponding to the alarm information, and refers to a transfer determination table 46 corresponding to the specified monitoring point. The generation unit 44 refers to the transfer determination table 46 corresponding to the monitoring point, and generates an alarm transfer signal based on a received alarm in the case where the category of the alarm included in the alarm information indicates that a transfer is to be performed. FIG. 6 illustrates an example of the setting table 47. The setting table 47 illustrated in FIG. 6 is a table storing monitoring points 47A and bit strings 47B so that the monitoring points 47A are associated with the respective bit strings 47B each of which is a 16-bit bit string representing an alarm transfer signal. The bit strings 47B define alarm categories in units of one bit. In the case where a transfer of a received alarm is to be performed, the generation unit 44 generates an alarm transfer signal by performing switching in units of one bit within a bit string in accordance with the content of the received alarm. For example, in the case where the generation unit 44 generates an alarm transfer signal for a LOS alarm regarding the OTU4, the generation unit 44 refers to the setting table 47, sets the zeroth bit (bit 0) of the bit string to “1”, and generates the alarm transfer signal.

The generation unit 44 outputs the generated alarm transfer signal to a monitoring point corresponding to the alarm information. For example, in the case of an alarm regarding the OTU4, the monitoring point is the second I/F 23, which has processed the OTU4 including the alarm. In the case of an alarm regarding an OTU2, the monitoring point corresponds to the first I/F 11 that has processed the OTU2 including the alarm. For example, in the case of an alarm regarding the OTU2 #2, the monitoring point is the first I/F 11 #2, which has processed the OTU2 #2 including the alarm. In the case of an alarm regarding an ODU0, the monitoring point corresponds to the ODU processing unit 21 that has processed the ODU0 including the alarm. For example, in the case of an alarm regarding an ODU0 #77, the monitoring point is an ODU processing unit 21 #77, which has processed the ODU0 #77 including the alarm.

For example, the generation unit 44 receives an alarm regarding and the allocation port number of the OTU4, and in the case where the alarm is to be transferred, the generation unit 44 generates an alarm transfer signal for the alarm and transfers the generated alarm transfer signal to the second I/F 23, the monitoring point. As a result, the second I/F 23 is able to transfer the alarm transfer signal regarding the alarm regarding the OTU4 to a block of the next stage.

In the case where the generation unit 44 has received an alarm regarding the OTU2 #2, the generation unit 44 transfers an alarm transfer signal to the first I/F 11 corresponding to the OTU2 #2. As a result, the first I/F 11 corresponding to the OTU2 #2 is able to transfer the alarm transfer signal regarding the alarm regarding the OTU2 #2 to a block of the next stage. In addition, in the case where the generation unit 44 has received an alarm regarding an ODU0 #80, the generation unit 44 transfers an alarm transfer signal regarding the alarm to the ODU processing unit 21 corresponding to the ODU0 #80. As a result, the ODU processing unit 21 corresponding to the ODU0 #80 is able to transfer the alarm transfer signal regarding the alarm regarding the ODU0 #80 to a block of the next stage.

In the transmission system 1, the determination unit 41 included in the alarm transfer unit 40 illustrated in FIG. 3 receives alarm information such as alarms, frame pulses, and type categories from the first I/Fs 11, the second I/F 23, and the ODU processing units 21.

The determination unit 41 refers to the priority rank table 45, and determines priority ranks in accordance with the type categories of the alarm information. The determination unit 41 determines the priority ranks of pieces of alarm information and allocates, based on the determined priority ranks, allocation ports P within the scheduler unit 43 to the respective pieces of alarm information. For example, alarm information regarding the OTU4 is allocated to the allocation port P1, which has the first priority rank, and pieces of alarm information regarding OTU2s #1 to #10 are allocated to the allocation ports P2 to P11, which have the second to eleventh priority ranks. Pieces of alarm information regarding ODU0s #1 to #80 are allocated to the allocation ports P12 to P91, which have the twelfth to ninety-first priority ranks. For example, in the case where there is no alarm information regarding the OTU2s #1 to #4, the alarm information regarding the OTU4 is allocated to the allocation port P1, which has the first priority rank, the pieces of alarm information regarding the OTU2s #5 to #10 are allocated to the allocation ports P2 to P7, which have the second to seventh priority ranks, and the pieces of alarm information regarding the ODU0s after the OTU2 #10 are allocated to the allocation port P8 and subsequent allocation ports, which have the eighth to subsequent priority ranks. For example, after determining the priority ranks of the respective pieces of alarm information, the determination unit 41 allocates the pieces of alarm information to the allocation ports P corresponding to the priority ranks.

The determination unit 41 outputs an alarm included in the alarm information having the first priority rank to the allocation port P1 having the first priority rank, and also outputs a frame pulse included in the alarm information to the FF 42 corresponding to the allocation port P1. The FF 42 corresponding to the allocation port P1 outputs a request “H” to the allocation port P1 within the scheduler unit 43 in accordance with input of the frame pulse.

The determination unit 41 outputs an alarm included in the alarm information having the second priority rank to the allocation port P2 having the second priority rank, and also outputs a frame pulse included in the alarm information to the FF 42 corresponding to the allocation port P2. The FF 42 corresponding to the allocation port P2 outputs a request “H” to the allocation port P2 within the scheduler unit 43 in accordance with input of the frame pulse. For example, the determination unit 41 outputs, in accordance with priority ranks, alarms included in pieces of alarm information to allocation ports having the priority ranks, and also outputs frame pulses included in the pieces of alarm information to the FFs 42 corresponding to the allocation ports P. The FFs 42 corresponding to the allocation ports P output a request “H” to the allocation ports P within the scheduler unit 43 in accordance with input of the frame pulses.

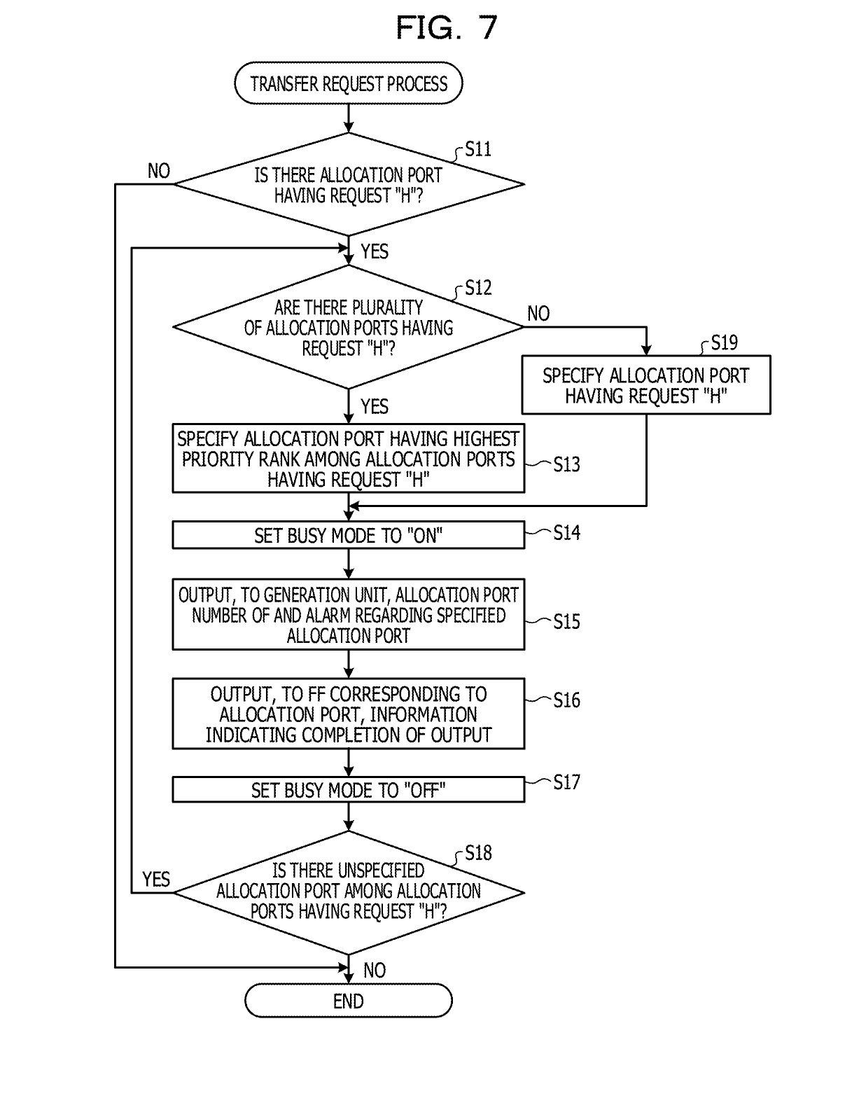

The scheduler unit 43 monitors alarm information having a request “H” through the allocation ports P. FIG. 7 illustrates an example of a processing operation of the scheduler unit 43 involved in a transfer request process. In the transfer request process illustrated in FIG. 7, the allocation ports P are sequentially specified in descending order from the highest priority rank among allocation ports P having a request “H”, and the generation unit 44 is requested to transfer alarm information regarding the specified allocation ports P.

In FIG. 7, the scheduler unit 43 determines whether or not there is an allocation port P having a request “H” (operation S11). In the case where there is an allocation port P having a request “H” (yes in operation S11), the scheduler unit 43 determines whether or not there are a plurality of allocation ports P having a request “H” (operation S12).

In the case where there are a plurality of allocation ports P having a request “H” (yes in operation S12), the scheduler unit 43 specifies the allocation port P having the highest priority rank among the allocation ports P having a request “H” (operation S13), and sets the BUSY mode to ON (operation S14).

After setting the BUSY mode to ON, the scheduler unit 43 outputs, to the generation unit 44, an alarm input to the specified allocation port P and an allocation port number used to identify the allocation port P (operation S15). After outputting the alarm regarding and the allocation port number of the specified allocation port P to the generation unit 44, the scheduler unit 43 outputs, to the FF 42 corresponding to the specified allocation port P, “H” that indicates completion of output (operation S16). As a result, the FF 42 switches the request from “H” to “L” in response to input of “H” indicating completion of output.

After outputting “H” indicating completion of output to the FF 42 corresponding to the specified allocation port P, the scheduler unit 43 switches and sets the BUSY mode from ON to OFF (operation S17). After setting the BUSY mode to OFF, the scheduler unit 43 determines whether or not there is an unspecified allocation port P among the allocation ports P having a request “H” (operation S18). In the case where there is an unspecified allocation port P (yes in operation S18), the process proceeds to operation S12 in order to determine whether or not there are a plurality of allocation ports P having a request “H”, the determination being performed by the scheduler unit 43. In the case where there is no unspecified allocation port P (no in operation S18), the scheduler unit 43 ends the processing operation illustrated in FIG. 7.

In addition, in the case where there is no allocation port P having a request “H” (no in operation S11), the scheduler unit 43 ends the processing operation illustrated in FIG. 7. In the case where there is no plurality of allocation ports P having a request “H” (no in operation S12), the scheduler unit 43 specifies the allocation port P having a request “H” (operation S19), and the process proceeds to operation S14 in order to set the BUSY mode to ON.

The scheduler unit 43, which executes the transfer request process illustrated in FIG. 7, specifies an allocation port P having a high priority rank among the allocation ports P having a request “H”, and outputs to the generation unit 44 an alarm input to and the allocation port number of the allocation port P. As a result, the scheduler unit 43 is able to request the generation unit 44 to generate an alarm transfer signal for the alarm regarding the specified allocation port P and transfer the alarm transfer signal.

In the case where the scheduler unit 43 has specified an allocation port P having a high priority rank among the allocation ports P having a request “H”, the scheduler unit 43 sets the BUSY mode to ON and causes the BUSY mode to stay ON until output of the alarm regarding and the allocation port number of the specified allocation port P is completed. As a result, the scheduler unit 43 prohibits specification of allocation ports P other than the specified allocation port P, and outputs, to the generation unit 44, alarms serially in accordance with priority ranks.

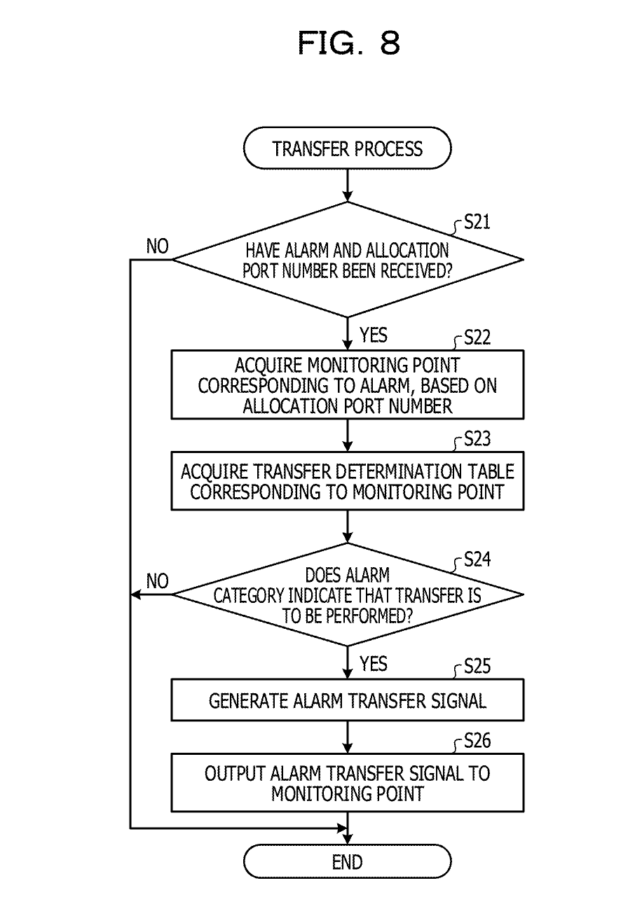

FIG. 8 illustrates an example of a processing operation of the generation unit 44 involved in a transfer process. In the transfer process illustrated in FIG. 8, an alarm transfer signal is generated based on an alarm and an allocation port number received from the scheduler unit 43, and the generated alarm transfer signal is transferred to a monitoring point. In FIG. 8, the generation unit 44 determines whether or not an alarm and an allocation port number have been received from the scheduler unit 43 in units of one allocation port (operation S21).

In the case where the generation unit 44 has received an alarm and an allocation port number (yes in operation S21), the generation unit 44 acquires, from the determination unit 41, a monitoring point corresponding to the alarm, based on the allocation port number (operation S22). Since the determination unit 41 identifies allocation ports P to which pieces of alarm information are allocated and that correspond to respective monitoring points, the determination unit 41 specifies a monitoring point corresponding to alarm information from an allocation port number used to identify an allocation port P.

The generation unit 44 acquires a transfer determination table 46 corresponding to the acquired monitoring point (operation S23). The generation unit 44 refers to the transfer determination table 46 corresponding to the acquired monitoring point, and determines whether or not the alarm category of the alarm indicates that a transfer is to be performed (operation S24). In the case where the alarm category indicates that a transfer is to be performed (yes in operation S24), the generation unit 44 identifies the content of the alarm, and generates an alarm transfer signal based on the identified context of the alarm (operation S25). The generation unit 44 generates, as illustrated in FIG. 6, an alarm transfer signal by setting a certain bit of a bit string of the alarm transfer signal to “1” corresponding to the content of the alarm.

After generating the alarm transfer signal, the generation unit 44 outputs the generated alarm transfer signal to the monitoring point corresponding to the alarm (operation S26), and the generation unit 44 ends the processing operation illustrated in FIG. 8. In the case where the generation unit 44 has not received an alarm and an allocation port number (no in operation S21), the generation unit 44 ends the processing operation illustrated in FIG. 8. In the case where the alarm category indicates that a transfer is not to be performed (no in operation S24), the generation unit 44 ends the processing operation illustrated in FIG. 8. As a result, useless alarms may not be transferred to monitoring points.

In the case where the generation unit 44 has received an alarm and an allocation port number in units of one allocation port P, the generation unit 44, which executes the transfer process illustrated in FIG. 8, generates an alarm transfer signal, and outputs the generated alarm transfer signal to a monitoring point corresponding to the allocation port number. As a result, for each of the monitoring points, the generation unit 44 receives an alarm, and transfers an alarm transfer signal regarding the alarm to the monitoring point.

In the case where the alarm category indicates that a transfer is to be performed, the generation unit 44 generates an alarm transfer signal based on the content of the alarm, and outputs the generated alarm transfer signal to a monitoring point. As a result, the generation unit 44 is able to output, to the monitoring point, the alarm transfer signal for the alarm for which it is indicated that an alarm transfer is to be performed.

In the case where the alarm category indicates that a transfer is not to be performed, although the generation unit 44 identifies the content of the alarm, the generation unit 44 does not generate an alarm transfer signal. As a result, useless alarms may not be transferred.

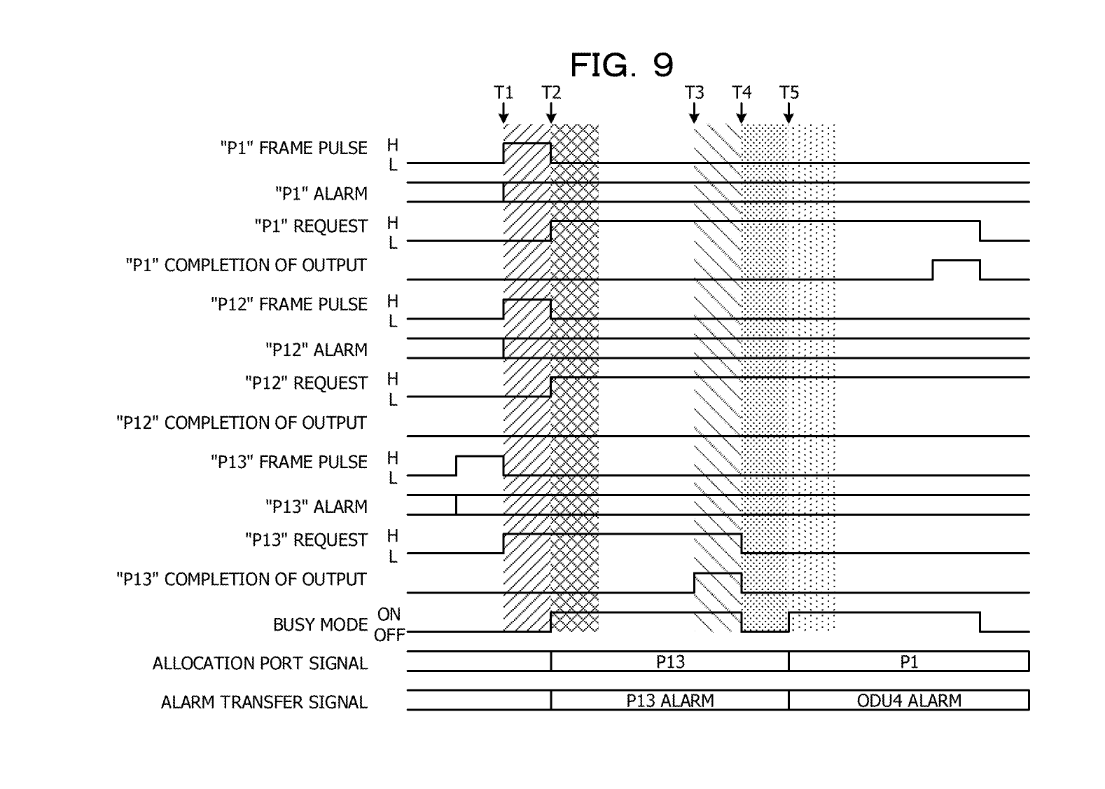

FIG. 9 illustrates an example of a timing chart of signals involved in alarm transfer. For example, allocation information regarding the allocation ports P1, P12, and P13 is input, and the highest priority rank is P1, the next highest priority rank is P12, and the following priority rank is P13.

At a timing prior to a first timing T1, the determination unit 41 outputs a frame pulse included in alarm information to the FF 42 corresponding to the allocation port P13, and also outputs an alarm to the allocation port P13. The FF 42 corresponding to the allocation port P13 outputs a request “H” to the scheduler unit 43 at the first timing T1. Because only the alarm information regarding the allocation port P13 has a request “H” and the BUSY mode is OFF at the first timing T1, the scheduler unit 43 sets the BUSY mode to ON at a second timing T2. In accordance with the BUSY mode, which is ON, the scheduler unit 43 starts generation of an alarm transfer signal regarding the alarm information regarding the allocation port P13.

At a third timing T3, at which output of the alarm regarding the alarm information regarding and the allocation port number corresponding to the allocation port P13 is completed, the scheduler unit 43 outputs information regarding completion of output to the FF 42 corresponding to the allocation port P13. The scheduler unit 43 switches the BUSY mode from ON to OFF at a fourth timing T4. As a result, the FF 42 corresponding to the allocation port P13 switches the request from “H” to “L” and outputs the request “L” in response to completion of output.

At the first timing T1, the determination unit 41 outputs a frame pulse included in alarm information to the FF 42 corresponding to the allocation port P1, and also outputs an alarm to the allocation port P1. The FF 42 corresponding to the allocation port P1 outputs a request “H” to the scheduler unit 43 at the second timing T2.

At the first timing T1, the determination unit 41 outputs a frame pulse included in alarm information to the FF 42 corresponding to the allocation port P12, and also outputs an alarm to the allocation port P12. The FF 42 corresponding to the allocation port P12 outputs a request “H” to the scheduler unit 43 at the second timing T2.

For example, because the BUSY mode is ON at the second timing T2, the scheduler unit 43 does not accept processing of alarm information other than processing of the alarm information regarding the allocation port P13, for which processing is currently being performed. When the BUSY mode is switched to OFF at the fourth timing T4, the scheduler unit 43 specifies the alarm information regarding the allocation port P1 having a high priority rank among allocation ports P corresponding to alarm information having a request “H”. Because the BUSY mode is OFF, the scheduler unit 43 sets the BUSY mode to ON at a fifth timing T5, and starts generation of an alarm transfer signal regarding the alarm information regarding the allocation port P1.

The ADM 5 stores alarms corresponding to monitoring points in the alarm transfer unit 40, which is a single alarm transfer unit, determines priority ranks regarding access to the alarms in accordance with the categories of signals passing through the respective monitoring points, and accesses, based on the priority ranks, the stored alarms corresponding to the respective monitoring points. Since the number of alarm transfer units arranged at the monitoring points is small, the circuit scale of the alarm transfer units may be made small in the entirety of the ADM 5, and the power consumption may be reduced. For example, in the case where there are 91 monitoring points (10 OTU2 ports, 1 OTU4 port, 80 ODU0 ports), compared with a case where 91 alarm transfer units are arranged, one alarm transfer unit 40 is arranged, and thus the power consumption is reduced.

In the ADM 5, higher priority ranks regarding alarm access, for example, alarm transfer are set for signal categories with higher signal transmission rates, and thus alarm access to the OTU4, which has a high signal-transmission speed, may be executed in a prioritized manner.

The ADM 5 refers to the transfer determination table 46 storing, for respective alarm categories, pieces of transfer determination information indicating whether a transfer is to be performed. In the case where an alarm is to be transferred, the ADM 5 outputs the alarm to a monitoring point, and in the case where the alarm is not to be transferred, the ADM 5 does not output the alarm to the monitoring point. As a result, useless alarms may not be transferred in the ADM 5. In the ADM 5, transfer determination tables 46 are provided at the respective monitoring points, and whether or not an alarm is to be transferred is determined at each monitoring point. Thus, useless alarms may not be transferred.

The determination unit 41 refers to the priority rank table 45, and determines priority ranks regarding alarm access for respective signals. The scheduler unit 43 may refer to the priority rank table 45, and may also determine priority ranks regarding alarm access for the respective signals.

In the ADM 5, alarms corresponding to the respective monitoring points are stored in the scheduler unit 43, and the stored alarms corresponding to the respective monitoring points are accessed based on the priority ranks. A memory is shared to store alarms corresponding to the respective monitoring points, and thus the circuit scale is reduced. Since the alarms corresponding to the respective monitoring points are accessed based on the priority ranks, even when the memory is shared to store alarms, the alarms may be efficiently accessed.

Priority ranks regarding alarm transfer (alarm access) may be set for the respective signal categories, and priority ranks regarding alarm transfer (alarm access) may be set for the respective monitoring points (ports). The efficiency of access to alarms stored in the same memory may be improved.

The generation unit 44 acquires, from the determination unit 41, monitoring points corresponding to the pieces of alarm information and to which allocation port numbers are allocated. However, the generation unit 44 may be provided with a table storing the monitoring points corresponding to the pieces of alarm information, and may specify a monitoring point corresponding to a piece of alarm information from the table, without acquiring the monitoring point from the determination unit 41.

The ADM 5 is applied to an OTU in which LO-ODUs are nested and multiplexed; however, the ADM 5 may also be applied to, for example, an OTU in which ODUs are nested in a plurality of stages, two or more stages, and multiplexed. A combination pattern of ODUs to be stored in an OTU may also be changed as appropriate. The ADM 5 including 10 OTU2 ports, 1 OTU4 port, and 80 ODU0 ports may be provided, ADMs other than the ADM 5 may also be provided, and the designs of the ADM 5 and ADMs may be changed as appropriate.

In the transfer determination table 46 illustrated in FIG. 5, pieces of transfer determination information are stored for the respective alarm categories, and all the alarm categories are set such that a transfer is to be performed; however, the stored content is changeable as appropriate. For example, for each of the monitoring points, a piece of transfer determination information may be set, in accordance with the arrangement position of the monitoring point, such that a transfer is to be performed or a transfer is not to be performed. The number of useless alarm transfers may be reduced in accordance with the arrangement positions of the monitoring points.

The number of the alarm transfer units 40 may be one, or may also be a number smaller than the number of the monitoring points. For example, in the case where two alarm transfer units 40 are provided, a processing load may be distributed. Since an alarm transfer unit is not arranged at every monitoring point, the circuit scale may be reduced and also the power consumption may be reduced.

For example, the maximum allowable capability for the case where the system clock is 170 MHz and five clocks are used for the alarm transfer process changes in accordance with a signal category having the fastest transmission rate. According to the current OTN standards, the signal category having the fastest transmission rate is OTU4, and thus seven clocks are used for an OH monitoring process. The processing time period is 170 MHz×5=29.412 ns, and the transmission rate of the OTU4 is 1.168 ns. Thus, the OTU4 practically and simultaneously processes approximately a maximum of 39 pieces of alarm information.

ADMs 5 supporting the OTN system through which a signal is received in which signals having different transmission rates are multiplexed may also be provided. The above-described technology may not only be applied to the OTN system but also be applied to communication systems through which a signal is received in which signals having different transmission rates are multiplexed.

The entirety or a portion of each illustrated unit may be functionally or physically distributed or integrated in arbitrary units in accordance with various loads, use states, and the like.

All of or an arbitrary portion of various processing functions performed in each device may be executed on a central processing unit (CPU) or a microcomputer, such as a micro processing unit (MPU) or a micro controller unit (MCU). All of or an arbitrary portion of the various processing functions may be executed on a program that performs an analysis and execution on the CPU or a microcomputer, such as the MPU or the MCU, or on a hardware device using wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A receiving apparatus comprising:
a memory configured to store information including priority ranks for accessing pieces of warning information ; and
a controller configured to extract the pieces of warning information from signals having different transmission rate, access, in descending order of the priority ranks, the pieces of warning information stored in a storage, and execute a transfer process.

2. The receiving apparatus according to claim 1,
wherein the priority ranks regarding the pieces of warning information are associated with respective categories of the signals in the memory.

3. The receiving apparatus according to claim 1,
wherein the priority ranks are set to become higher as transmission rates of the signals become higher in the memory.

4. The receiving apparatus according to claim 1,
wherein the priority ranks regarding the pieces of warning information are associated with respective monitoring points in which the transfer process is performed on the signals in the memory.

5. The receiving apparatus according to claim 1,
wherein the controller accesses one of the pieces of warning information, and outputs an accessed piece of warning information to a monitoring point among the monitoring points.

6. The receiving apparatus according to claim 5,
wherein the controller determines, based on pieces of transfer determination information indicating whether or not the pieces of warning information are to be transferred for respective categories of the pieces of warning information, whether or not one of the pieces of warning information is to be output to a monitoring point among the monitoring points.

7. A warning information transfer method, comprising:
receiving signals having different transmission rates in a receiving apparatus;
extracting pieces of warning information from the signals;
storing the extracted pieces of warning information in a memory; and
executing, in descending order of priority ranks of the piece of warning information, a transfer process to a subsequent stage sequentially on the pieces of warning information in the memory.

8. The warning information transfer method according to claim 7,
wherein the priority ranks regarding the pieces of warning information are associated with respective categories of the signals.

9. The warning information transfer method according to claim 7,
wherein the priority ranks are set to become higher as transmission rates of the signals become higher.

10. The warning information transfer method according to claim 7,
wherein the priority ranks regarding the pieces of warning information are associated with respective monitoring points in which the transfer process is performed on the signals.

11. The warning information transfer method according to claim 7,
wherein one of the pieces of warning information is accessed, and an accessed piece of warning information is output to a monitoring point among the monitoring points.

12. The warning information transfer method according to claim 11, further comprising:
determining, based on pieces of transfer determination information indicating whether or not the pieces of warning information are to be transferred for respective categories of the pieces of warning information, whether or not one of the pieces of warning information is to be output to a monitoring point among the monitoring points.
